(19) United States
(12) Patent Application Publication
(10) Pub. No.: US 2009/0003345 A1
(43) Pub. Date: Jan. 1, 2009

(54) NETWORK DEVICE DYNAMIC HELP

(76) Inventors: Steve Chen-Lin Chang, Cupertino, CA (US); Ludwig Alexander Clemm, Los Gatos, CA (US); Jiabin Zhao, Saratoga, CA (US); Junekang Yang, Palo Alto, CA (US); Shyyunn Sheran Lin, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 11/769,591

(22) Filed: Jun. 27, 2007

(51) Int. Cl. H04L 12/28

(52) U.S. Cl. 370/392

(57) ABSTRACT

There are provided a method, system, logic and network device to provide additional information and at least one recommended action relating to error information reported by a feature module of the network device. The method comprises generating a request that includes error information reported by a feature module of a network device, the error information including one or more runtime parameters associated with the network device. The method further comprises transmitting the generated request and receiving a response to the request including additional information and the at least one recommended action relating to the error information, the additional information and the at least one recommended action being based at least in part on the one or more runtime parameters. The network device comprises a feature module to report error information including one or more runtime parameters associated with the network device, a help module to generate a request including the error information reported by the feature module and to receive a response to the request, the response including additional information and at least one recommended action relating to the error information, the additional information and the at least one recommended action being based at least in part on the one or more runtime parameters, and a communication module to transmit the generated request and to receive the response to the request.

### TECHNICAL FIELD

The disclosure relates generally to network devices. More particularly, example embodiments are directed to a system, method, logic and network device to provide additional information and recommendation (e.g., at least one recommended action) relating to error information reported by a feature module of the network device.

### BACKGROUND

Generally, a network device is a device that mediates data traffic in a computer network(s). The Internet is a conglomeration of different networks, including wide area networks (WANs), local area networks (LANs) and the like. A multiplicity of network devices mediates traffic across the different networks. Some examples of network devices include gateways, routers, switches, bridges, hubs, repeaters and the like. Other network devices may include hosts and terminal devices, including network devices such as Internet-protocol (IP) telephones and the like.

Each of the aforementioned network devices generally incorporates a display console that displays system messages relating to the particular network device to a user. The displayed system messages, which may be maintained in a system message log in the network device, suffer because of non-expressiveness. More specifically, the lack of system message detail and unavailability of more detailed information relating to system messages and recommended action(s) associated with the system messages represent major user concerns. Expressiveness in network device system messages improves the ability of the user to accurately pinpoint network-related or network device-related issues and makes network devices easier to use and manage. In addition, system messages are generally static and do not take runtime parameters or context information of the network device into account.

While it is possible for the user to turn to external applications and Web sites for more information using a personal computer for example, the need to do so is awkward and reminiscent of the “swivel chair syndrome” typically associated with non-integrated management applications. Furthermore, Web site access is not always practical as some service provider operations support environments do not allow access to the Internet. In addition, the information resulting from Web site access generally does not take the runtime parameters or context of the network device into account.

### BRIEF DESCRIPTION OF THE DRAWINGS

Some embodiments are illustrated by way of example and not limitation in the figures of the accompanying drawings in which:

FIG. 1 is a high-level block diagram of an example dynamic help system that facilitates a network device in dynamically retrieving additional information and at least one recommended action related to one or more system messages from a dynamic help service (DHS) server via an internal DHS client and display the additional information and the at least one recommended action to a user;

FIG. 2 is a block diagram of an example network device in accordance with the example dynamic help system of FIG. 1;

FIG. 3 is a high-level block diagram of another example dynamic help system that facilitates a network device in dynamically retrieving additional information and at least one recommended action related to one or more system messages from a dynamic help service (DHS) server via an external DHS client and displaying the additional information and the at least one recommended action to a user;

FIG. 4 is a block diagram of an example dynamic help service (DHS) client external to the network device in accordance with the dynamic help system of FIG. 3;

FIG. 5 is a block diagram of an example network device in accordance with the example dynamic help system of FIG. 3;

FIG. 6 is a block diagram of an example DHS server in accordance with example dynamic help systems of FIGS. 1 and 3;

FIG. 7 is a block diagram of an example DHS request including error information in accordance with example systems 100 and 300 of FIGS. 1 and 3;

FIG. 8 is flowchart that illustrates an example method performed by the example DHS server in accordance with FIGS. 1, 3 and 6;

FIG. 9 is a high-level block diagram of yet another example dynamic help system that facilitates a network device in dynamically retrieving additional information and at least one recommended action related to one or more system messages from a dynamic help service (DHS) server and displaying the additional information and the at least one recommended action to a user;

FIG. 10 is a block diagram of another example DHS server in accordance with the example dynamic help system of FIG. 9;

FIG. 11 is flowchart that illustrates an example method performed by the example DHS server in accordance with FIGS. 9-10;

FIG. 12 is flowchart that illustrates another example method performed by the example DHS server in accordance with FIGS. 9-10;

FIG. 13 is flowchart that illustrates an example method performed by the example network device in accordance with FIGS. 1, 2 and 9;

FIG. 14 is flowchart that illustrates an example method performed by the example network device in accordance with FIGS. 3, 5 and 9; and

FIG. 15 is a diagrammatic representation of machine in an example form of a computer system within which a set of instructions, for causing the machine to perform any one or more of the methodologies described herein in FIGS. 1-14, may be executed.

### DESCRIPTION OF EXAMPLE EMBODIMENTS

### Overview

In accordance with example embodiments, there are provided a method, system and logic for providing additional information and at least one recommended action relating to error information reported by a feature module of a network device. The method comprising: generating a request that includes error information reported by a feature module of a network device, the error information including one or more runtime parameters associated with the network device; transmitting the generated request; and receiving a response to the request, the response including additional information and at least one recommended action relating to the error information, the additional information and the at least one recommended action being based at least in part on the one or more runtime parameters.

In accordance with a another example embodiment, there is provided a network device comprising: a feature module to report error information including one or more runtime parameters associated with the network device; a help module to generate a request including the error information reported by the feature module, and to receive a response to the request, the response including additional information and at least one recommended action relating to the error information, the additional information and the at least one recommended action being based at least in part on the one or more runtime parameters; and a communication module to transmit the generated request and to receive the response to the request.

### Description

An example system, method, logic and network device to provide additional information and at least one recommended action relating to error information reported by a feature module of the network device are described. In the following description, for the purposes of explanation, numerous specific details are set forth in order to provide a thorough understanding of example embodiments. It will be evident, however, to one skilled in the art that an example embodiment may be practiced without these specific details.

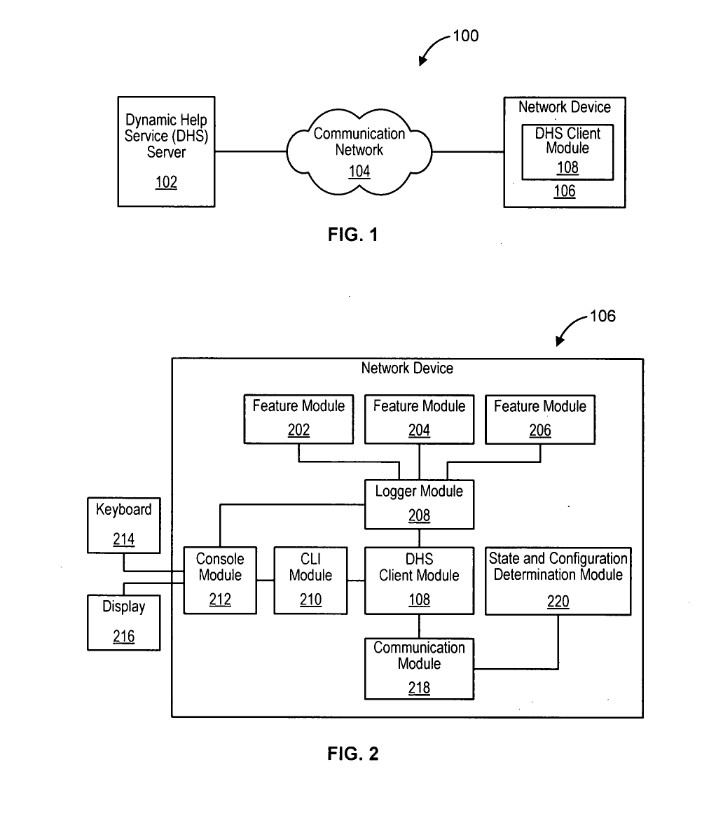

FIG. 1 is a high-level block diagram of an example dynamic help system 100 that facilitates a network device 106 in dynamically retrieving additional information and at least one recommended action related to one or more system messages from a dynamic help service (DHS) server 102 via an internal DHS client 108 and displaying the additional information and the at least one recommended action to a user. The example dynamic help system 100 includes a dynamic help service (DHS) server 102, a network 104 and a network device 106. For the purposes of clarity and conciseness, only one network device 106 is illustrated in FIG. 1; it is noted, however, that multiple network devices 106 may be included in system 100 as may be desired. The network device 106 may be communicatively interconnected to the DHS server 102 via the communication network 104. The DHS server 102 may be deployed in the same (or different) management network as the network device 106, and it may reside on a host device, a Web appliance, a blade on an integrated services router, and the like. The dynamic help system 100 is implemented as a client-server system. More specifically, the network device includes a DHS client module 108 adapted to communicate with the DHS server 102.

Further with reference to FIG. 1, the communication network 104 may be any conventional network, including the Internet, Wide Area Network (WAN), Metropolitan Area Network (MAN), Campus Area Network (CAN), Local Area Network (LAN), Home Area Network (HAN), wireless (802.11), satellite, as well as a variety of different combinations thereof. The communication over network 104 between DHS server 102 and network device 106 may be accomplished via a variety of different protocols, including the Transfer Control Protocol/Internet Protocol (TCP/IP) and hyper text transfer protocol (HTTP), any proprietary protocol, as well as other well known or to be developed protocols.

Yet further with reference to FIG. 1, in operation the network device 106 may generate one or more system messages including error information relating to an error (or fault) in operation of the network device 106 or the communication network 104, or other error (or fault) conditions, and may further transmit at least one of the one or more system messages to the DHS server 102, requesting amplification of the error and recommendation (e.g., at least one recommended action) as to how to resolve or correct the error (e.g., via a DHS request). The error information includes one or more runtime parameters associated with the network device 106. Upon receipt of the at least one message, the DHS server 102 may perform a lookup or search for additional information and recommendation (e.g., at least one recommended action) relating to the error using the error information and based at least in part on the one or more runtime parameters of the at least one message, and may further return the additional information and the recommendation to the network device 106. Upon receipt, the network device 106 may display the received additional information and the at least one recommended action of the recommendation.

FIG. 2 is a block diagram of an example network device 106 in accordance with the example dynamic help system 100 of FIG. 1. The example network device may be a router and may include plural feature modules 202-206 that may perform different operations of the network device 106, such as, for example, switching, authentication and routing, among other operations. Only three feature modules 202-206 are depicted for clarity and conciseness. It is to be noted, however, that the number and type of feature modules 202-206 may vary in accordance with the type and version of the network device 106. The feature modules 202-206 may be implemented in hardware, software or combination thereof (e.g., firmware and the like). For example, the network device 106 may be a router, and example feature module 202 may be a multi-protocol-label-switching (MPLS) module, which provides a unified data-carrying service for both circuit-based clients and packet-switching clients and may be used to carry many different kinds of traffic, including IP packets, as well as native ATM, SONET, and Ethernet frames. As another example, example feature module 204 may be an authentication/authorization/accounting (AAA) module that may provide router security. Yet another example may include feature module 206, which may be a border gateway protocol (BGP) module that provides exchange of routing information for the Internet, such as between Internet service providers (ISPs). Additional or different modules may be provided depending on the type and version of the network device 106.

Further with reference to FIG. 2, each of the feature modules 202-206 reports or generates one or more system messages associated with its respective operation and transmits the one or more system messages to the logger module 208. The error information of a system message includes a feature module ID of the feature module (e.g., 202-206) that has generated the system message, a severity level of the system message and an error message. The error message includes a mnemonic part, which is a short identifier that identifies the system message and a message part, which includes one or more runtime parameters associated with a format string (e.g., amplified descriptive information or additional information described below) for the system message. For example, the mnemonic part “%ENV_MON-2-TEMP” may be related by the DHS server 102 to an example format string “[chars temperature has reached [chars] level at [dec] (C),” which involves three runtime parameters (e.g., a module name, a criticality level and a temperature) in the message part. Thus, the example format string (e.g., amplified descriptive information or additional information returned by DHS server 102) may be as follows: “chassis temperature has reached warning level at 80 (C).” In generating the system message, the feature module (e.g., 202-206) collects (e.g., via network device 106 APIs or the like) the required one or more runtime parameters included in the system message. In an example embodiment, multiple runtime parameters are collected for a particular system message. The runtime parameters may include a time stamp associated with a system message, event-related parameters (e.g., temperature, module name, link status, traffic rate, and the like), network device configuration, network device image release/version, user subscription policy details, as well as any other parameters not enumerated. It should be noted however that a NULL parameter may be provided as a runtime parameter in example cases in which the format string may not require particular runtime parameters to be collected.

Still further with reference to FIG. 2, the logger module 208 may log or store the received system messages in one or more session log files (not shown) that the logger module 208 may maintain. The logger module 208 may instead buffer the received system messages in a memory buffer (not shown). Furthermore, the logger module 208 transmits the received messages in a user-configured format to the console module 212 for display on a display 216 to a user. The console module 212 is an integrated component that communicatively couples keyboard 214 and display 216 to command line interface (CLI) module 210. The CLI module 210 provides the user with the ability to configure the DHS client module 108 to request additional information/recommendation from the DHS server 102 automatically or the user may manually request such information/recommendation. More specifically, the user may explicitly request information/recommendation about a particular message, for example, by using a CLI command (not shown) via keyboard 214 or by selecting a corresponding option from a diagnostics menu (not shown).

Yet further with reference to FIG. 2, the user may likewise configure the DHS client module 108 using a CLI command or menu option via keyboard 214 to automatically request information/recommendation for certain system messages, such as system messages of a particular severity level, system messages associated with a particular session and error message, as well as other configurations (e.g., system messages from a particular feature module 202-206), and the like. Consistently with the manual request or automatic configuration, the DHS client module 108 obtains a particular system message from logger module 208, forms a well-formatted request message (e.g., DHS request) including error information, an example of which is shown and described below in reference to FIG. 7, and transmits the request message to the communication module 218 that transmits or forwards the request message to the DHS server 102 over network 104. As described hereinabove in reference to FIG. 1, the request may be transmitted in accordance with any protocol, such as TCP/IP, HTTP, proprietary protocol, or any other well known or to be developed protocol.

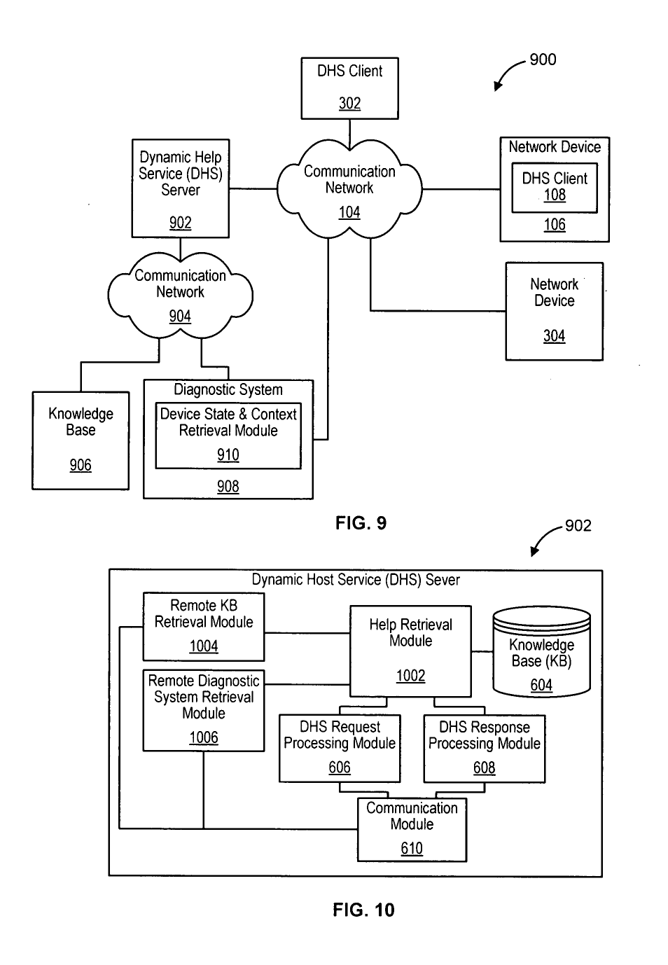

Additionally with reference to FIG. 2, the network device 106 also includes a state and configuration determination module 220 that may receive via communication module 218 a request to determine the state and configuration information of the network device 166 from a network system (e.g., diagnostic system 908 of FIG. 9). In response to the request, the state and configuration determination module 220 determines the state and configuration of the network device 106 and via communication module 218 transmits a response that includes the state and configuration information to the network system (e.g., diagnostic system 908 of FIG. 9).

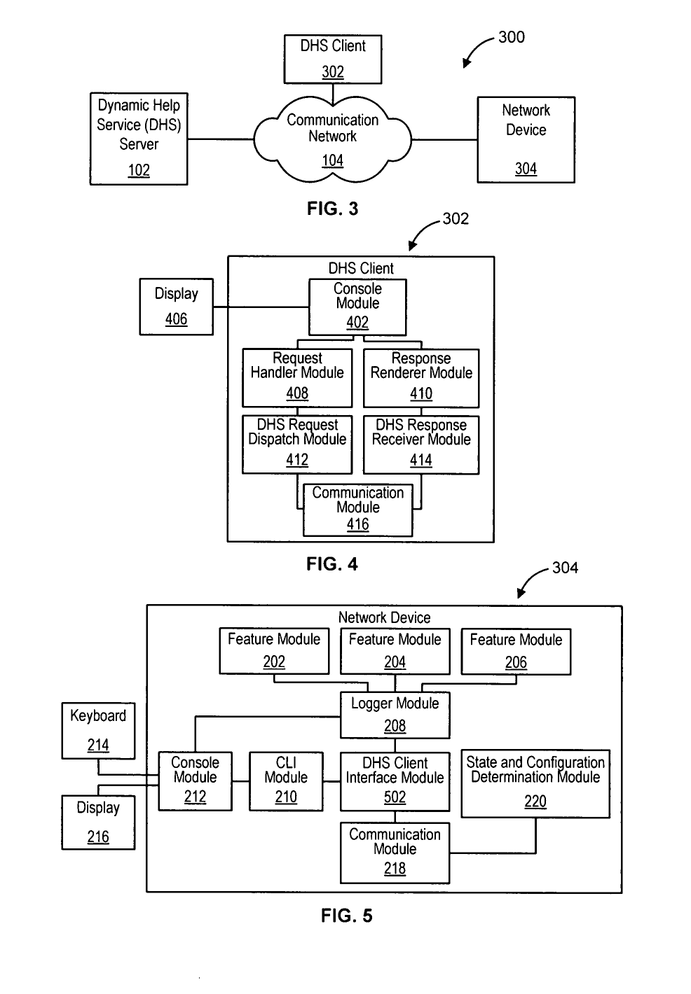

FIG. 3 is a high-level block diagram of another example dynamic help system 300 that facilitates a network device 304 in dynamically retrieving additional information related to one or more system messages from a dynamic help service (DHS) server 102 via an external DHS client 302 and displaying the additional information to a user. This example dynamic help system 300 includes a dynamic help service (DHS) server 102, a network 104, a DHS client 302 and a network device 304. For the purposes of clarity and conciseness, only one network device 304 is illustrated in FIG. 3; it is noted, however, that multiple network devices 304 may be included in example system 300 as may be desired. The network device 304 may be communicatively interconnected to the DHS client 302, which in turn is communicatively interconnected to the DHS server 102, via the communication network 104. Just like the dynamic help system 100 of FIG. 1, the example dynamic help system 300 is also implemented as a client-server system in which the DHS client 302 is adapted to communicate with the DHS server 102. However, in this example system 300, the DHS client 302 is not a module of the network device 304, but rather is disposed on the network 104 in communication with the network device 304. As such, multiple network devices 304 may transmit system messages to the DHS client 302 for ultimate transmission to the DHS server 102. Additionally, there may be multiple DHS clients 302, each of which may communicate with multiple network devices 304. A particular DHS client 302 may communicate with a desired set or category of network devices, such as routers, bridges, terminal devices (e.g., VoIP telephones), and the like. Likewise, there may also be multiple DHS servers 102, each of which may serve a different category of network devices 304 described above. A variety of different configurations is possible.

Now further with reference to FIG. 3, in operation the network device 304 may generate one or more system messages including error information relating to an error or fault in operation of the network device 304 and may further transmit at least one of the one or more system messages to the DHS client 302, requesting amplification of the error and recommendation as to how to resolve or correct the error. It is noted that the error information may include one or more runtime parameters associated with the network device 304. In turn, the DHS client 302 may forward the at least one of the one or more system messages to the DHS server 102 (e.g., via a DHS request). Upon receipt of the at least one system message, the DHS server 102 may perform a lookup or search for additional information and recommendation (e.g., at least one recommended action) relating to the error using the error information and based at least in part on the one or more runtime parameters of the at least one system message, and may further return the additional information and recommendation to the DHS client 302, which in turn forwards the additional information and recommendation to the network device 304. Upon receipt, the network device 304 may display the received additional information and the at least one recommended action of the recommendation to the user.

FIG. 4 is a block diagram of an example DHS client 302 external to the network device 304 in accordance with the dynamic help system of FIG. 3. More specifically, a DHS request dispatch module 412 of DHS client 302 receives a request including error information over the communication network 104 via communication module 416 from the network device 304 in a format associated with the network device 304. The DHS request dispatch module 412 forwards the received request to a request handler module 408 to format the received request into a DHS request having a common format (e.g., a well-formatted request message described in reference to FIG. 7 below). More specifically, as different network devices and versions thereof may formulate differently-formatted requests, the request handler module 408 converts or formats the differently-formatted requests into a common well-formatted request (e.g., DHS request). After formulating the DHS request, the request handler module 408 transmits the DHS request to the DHS request dispatch module 412, which dispatches the DHS request via communication module 416 to the DHS server 102 over network 104. The request handler module 408 also transmits the received request to a console module 402, which displays the received request on a display 406. Thereafter, the DHS response receiver module 414 receives via communication module 416 over network 104 a DHS response in response to the DHS request from the DHS server 102 and transmits the DHS response to the response renderer module 410, which generates from the DHS response a response message in formatting suitable for the network device 304. The response renderer module 410 transmits the generated formatted response message to the DHS response receiver module 414. The DHS response (as well as formatted response message generated therefrom) includes explanation (e.g., amplification) of the error and recommendation (e.g., at least one recommended action). The response renderer module 410 transmits the received DHS request to the console module 402, which displays the DHS request on the display 406. The response renderer module 410 further transmits the generated response message to the DHS response receiver module 414 module for dispatch of the response message via communication module 416 to the network device 304.

FIG. 5 is a block diagram of an example network device 304 in accordance with the example dynamic help system 300 of FIG. 3. Just like network device 106 of FIG. 1, the example network device 304 may include plural feature modules 202-206 that may perform different operations of the network device 304, such as, for example, switching, authentication and routing, among other operations. The feature modules 202-206 may be implemented in hardware, software or combination thereof (e.g., firmware and the like). Each of the feature modules 202-206 generates one or more system messages including error information associated with its respective operation and transmits the one or more system messages to the logger module 208. The error information may include one or more runtime parameters associated with the network device 106. The logger module 208 may log or store the received system messages in a one or more session log files (not shown) that the logger module 208 may maintain, or the logger module 208 may instead buffer the received system messages in a memory buffer (not shown). Furthermore, the logger module 208 transmits the received messages to the console module 212 that may format the messages for display on a display 216 to a user. The console module 212 is an integrated component that communicatively couples keyboard 214 and display 216 to command line interface (CLI) module 210. The CLI module 210 provides the user with the ability to configure the DHS client interface module 502 to communicate with DHS client 302 to request additional information/recommendation for a particular system message.

Further with reference to FIG. 5, the user may likewise configure the DHS client interface module 502 using a CLI command or menu option via keyboard 214 to automatically communicate with DHS client 302 to request information/recommendation for certain system messages from the DHS client 302, such as system messages of particular severity level, system messages associated with a particular session and error message, as well as other configurations (e.g., system messages from a particular feature module 202-206). Consistently with the manual request or automatic configuration, the DHS client interface module 502 obtains a particular system message from logger module 208, and communicates the system message to the communication module 218 which transmits or forwards the system message to the DHS client 302 over network 104. In turn, DHS client 302 communicates with the DHS server 102 to retrieve additional information/recommendation for the system message and transmits the retrieved information/recommendation to the DHS client interface module 502.

Yet further with reference to FIG. 5, the network device 304 also includes a state and configuration determination module 220 that may receive via communication module 218 a request to determine the state and configuration information of the network device 106 from a network system (e.g., diagnostic system 908 of FIG. 9). In response to the request, the state and configuration determination module 220 determines the state and configuration of the network device 106 and via communication module 218 transmits a response that includes the state and configuration information to the network system (e.g., diagnostic system 908 of FIG. 9).

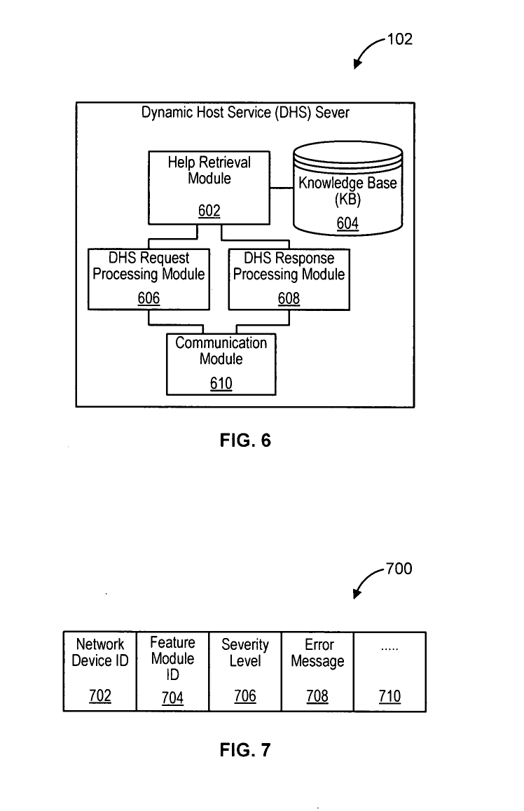

FIG. 6 is a block diagram of an example DHS server 102 in accordance with example dynamic help systems 100 and 300 of FIGS. 1 and 3. The DHS server includes a knowledge base (KB) 604 that maintains information relating to system messages, including amplified descriptive information of an error and recommendation as to how to resolve or correct the error identified in a system message. The DHS request processing module 606 receives a DHS request from the DHS client 108, 302 and extracts error information relating to a network device system message (e.g., feature module ID, severity level and error message including runtime parameters), an example of which is shown and described below in reference to FIG. 7. The DHS request processing module 606 transmits the extracted error information to a help retrieval module 602, which using the extracted error information including the runtime parameters queries the KB 604 for amplified descriptive information of the error (e.g., retrieving a particular format string and filling in the runtime parameters) and recommendation as to how to resolve the error. It is noted that different amplified descriptive information and recommendation may be retrieved based at least in part on the runtime parameters. Upon retrieving the amplified descriptive information and recommendation from the KB 604, the help retrieval module 602 transmits the retrieved information to the DHS response processing module 608, which generates a DHS response that includes the amplified information and recommendation and which transmits the DHS response to the communication module 610. Thereafter, the communication module 610 transmits the DHS response to the DHS client 108, 302 over communication network 104. It is noted that since DHS client 302 is external to the network device 304, the DHS client 302 formats the DHS response into a formatted response for the network device 304 and transmits that formatted response to the DHS client interface module 502 of the network device 304.

FIG. 7 is a block diagram of an example DHS request 700 including error information 704-710 in accordance with example systems 100 and 300 of FIGS. 1 and 3. The DHS request 700 includes a network device ID 702 that identifies a particular network device 106, 304 and error information 704-710 relating to a system message. More specifically, the feature module ID 704 identifies a particular feature module 202-206 that has issued a system message in the network device 106, 304. The severity level 706 identifies a severity level of the system message (e.g., from least critical to most critical), and the error message 708 identifies the particular error message the feature module 202-206 has issued. The error message 708 includes a mnemonic part and a message part. The mnemonic part and the message part are described above by way of example with reference to FIG. 2. Lastly, additional system message information 710 may be provided in the DHS request 700 as may be desired. For example, the additional system message information 710 may include a DHS feature subscriber support level, a type of the network device 106, 304, an image revision and/or specific configuration of firmware on the network device 106, 304 and the like.

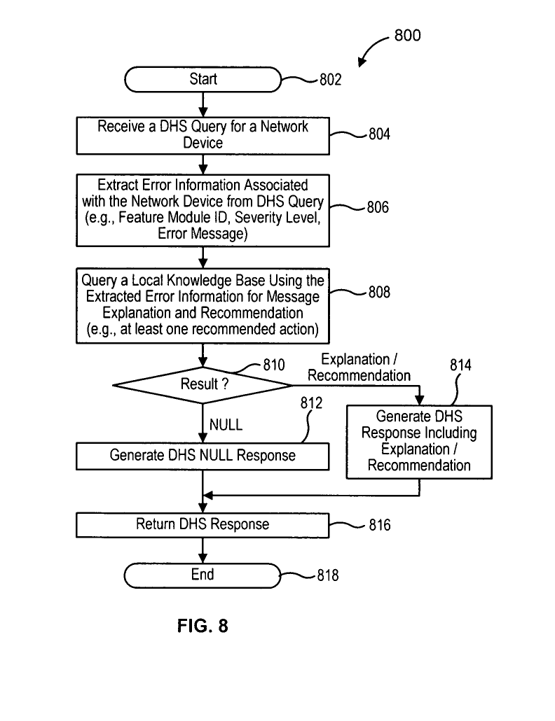

FIG. 8 is a flowchart that illustrates an example method 800 performed by the example DHS server 102 in accordance with FIGS. 1-6. The method begins at operation 802. At operation 804, the communication module 610 receives a DHS request 700 from DHS client 108, 302. At operation 804, DHS request processing module 606 extracts error information 704-710 associated with the network device 106, 304, as identified by network device ID 702, from the DHS request 700. More specifically, error information may include feature module ID 704, severity level 706, error message 708 (including runtime parameters) and any additional error information 710. At operation 808, the help retrieval module 602 queries the knowledge base (KB) 604 using the extracted error information including runtime parameters for amplification or explanation of error message and recommendation (e.g., at least one recommended action). If a result of the query at operation 810 is NULL, the DHS response processing module 608 generates a DHS NULL response at operation 812 and the communication module 610 returns the DHS this response to the DHS client 108, 302 at operation 816. Alternatively, if at operation 810, it is determined that the result of the query is not NULL (e.g., an explanation and recommendation retrieved), then the DHS response processing module 608 generates a DHS response that includes the explanation and recommendation at operation 814, and the communication module 610 returns the DHS this response to the DHS client 108, 302 at operation 816. The method 800 ends at operation 818.

FIG. 9 is a high-level block diagram of an yet another example dynamic help system 900 that facilitates a network device 106, 304 in dynamically retrieving additional information and at least one recommended action related to one or more system messages from a dynamic help service (DHS) server 902 and displaying the additional information and the at least one recommended action to a user. The dynamic help system 900 may include at least one network device 106 (which includes client 108), or at least one network device 304 that communicates to an external DHS client 302 (or multiple DHS clients 302 to each of which multiple network devices 304 communicate), or both types of network devices 106 and 304. For the purposes of clarity and conciseness, only one network device of each type 106, 304 is illustrated in FIG. 9; it is noted, however, that multiple network devices of each type 106, 304 may be included in example system 300 as may be particularly desired. These network devices 106, 304 were described in detail hereinbefore in reference to FIGS. 1-6 and this description will not be repeated but is incorporated herein in its entirety. Network device 106 may be communicatively interconnected to the DHS server 902 via the communication network 104, while network device 304 may be communicatively interconnected to DHS client 302 that is in turn is communicatively interconnected to the DHS server 902, via the communication network 104. The dynamic help service (DHS) server 902 includes all the functionality of DHS server 102 and also includes additional capabilities to communicatively interconnect to a remote knowledge base 906 and a remote diagnostic system 908 via communication 904, as will be described herein in reference to FIGS. 9-12.

Further with reference to FIG. 9, in operation the network device 106, 304 may generate one or more system messages including error information relating to an error or fault in operation of the network device 106, 304, and at least one of the one or more system messages may further be transmitted to the DHS server 902, requesting amplification of the error and recommendation as to how to resolve or correct the error (e.g., via a DHS request). In the case of network device 106, the at least one system message is transmitted from the network device to DHS server 902 via network 104, and in the case of network device 304, the at least one system message is transmitted from the network device to DHS client 302 and in turn from DHS client 302 to DHS server 902 via network 104. The error information may include one or more runtime parameters associated with the network device 106, 304. Upon receipt of the at least one message, the DHS server 102 may perform a local or remote lookup or search for additional information and recommendation (e.g., at least one recommended action) relating to the error using the error information and based at least in part on the one or more runtime parameters of the at least one system message, and may further return the additional information and recommendation to the network device 106 or network device 304 (via DHS client 302) using network 104. The local lookup or search performed by DHS server 902 (e.g., DHS server 102) was described in reference to FIG. 6.

Still further with reference to FIG. 9, in addition to the local look up or search, the DHS server 902 may perform a remote lookup or search for additional information from a remote knowledge base 906 and/or query a remote diagnostic system 908 using the error information and based at least in part on the one or more runtime parameters of the at least one system message. The remote knowledge base 906 maintains information relating to system messages, including amplified descriptive information of an error and recommendation as to how to resolve or correct the error identified in a system message. It is noted that the DHS server 902 (e.g., DHS server 102) may update its local knowledge base 604 (illustrated in FIG. 6) periodically from the remote knowledge base 906. The remote diagnostic system 908 may perform a diagnostic analysis of the at least one message (e.g., analysis of error information including the one or more runtime parameters). The remote diagnostic system 908 includes a device state and context retrieval module 910 that may contact via communication network 104 the state and configuration determination module 220 of the particular network device 106, 304 associated with the at least one system message to collect a current state and/or context of the network device 106, 304 and to perform a diagnostic analysis of the at least one message also using the collected state and/or context of the network device 106, 304. The state and/or context collected may include: link up/down state of an interface (e.g., which may explain why the at least one message was generated); a state of a memory (not shown) of the network device 106, 304, such as an overflow, an underflow or the like condition (e.g., which may explain why a certain operation performed by a feature module 202-206 failed); or that a certain feature module 202-206 has reached a predetermined limit (not shown) on a specific resource (not shown) having to deny services for the resource. In response to a lookup or analysis, the knowledge base 906 and/or the diagnostic system 908 returns amplified descriptive information of an error and recommendation (e.g., at least one recommended action) as to how to resolve the error identified in the at least one system message to the DSH server 902. The DHS server 902 returns any locally available information (via knowledge base 604), information from remote knowledge base 906 and/or diagnostic system 910 to the network device 106, 304 (via DHS client 302) associated with the at least one system message.

FIG. 10 is a block diagram of another example DHS server 902 in accordance with example dynamic help system 900 of FIG. 9. Similar to the DHS server 102 illustrated in FIG. 6, the DHS server 902 includes a knowledge base (KB) 604 that maintains information relating to system messages, including amplified descriptive information of an error and recommendation as to how to resolve or correct the error identified in a system message. The DHS sever 902 further includes a remote knowledge base (KB) retrieval module 1004 that interacts with the remote knowledge base 906 to retrieve amplified descriptive information of an error and recommendation as to how to resolve or correct the error identified in a system message. Yet further, the DHS server 902 also includes a remote diagnostic system retrieval module 1006 that interacts with the remote diagnostic system 908 to perform a diagnostic analysis of the system message (or contents thereof).

Further with reference to FIG. 10, in operation the DHS request processing module 606 receives a DHS request from the DHS client 108, 302 and extracts error information relating to a network device system message (e.g., feature module ID, severity level and error message including one or more runtime parameters), an example of which is shown and described in reference to FIG. 7. The DHS request processing module 606 transmits the extracted error information to a help retrieval module 1002, which using the extracted error information including one or more runtime parameters queries the KB 604 for amplified descriptive information of the error and recommendation as to how to resolve the error. The help retrieval module 1002 may further query the remote KB 906 and/or the remote diagnostic system 908 to obtain additional amplified descriptive information of the error and additional recommendation as to how to resolve the error. The help retrieval module 1002 determination as to whether and in what order to query the knowledge base 604, the remote knowledge base 906 and the remote diagnostic system 908 may be predetermined and/or may be based on a query policy (not shown) for a particular network device 106, 304. Upon retrieving the amplified information and recommendation from the knowledge base 604, knowledge base 906 and/or diagnostic system 908, the help retrieval module 1002 transmits the retrieved information to the DHS response processing module 608, which generates a DHS response that includes the amplified information and recommendation (from one or more of 604, 906, 908) and which transmits the DHS response to the communication module 610. Thereafter, the communication module 610 transmits the DHS response to the DHS client 108, 302 over communication network 104. In turn, DHS client 302 forwards the DHS response to an appropriate network device 304. Upon receipt, the network device 106, 304 may display the received additional information and recommendation to the user.

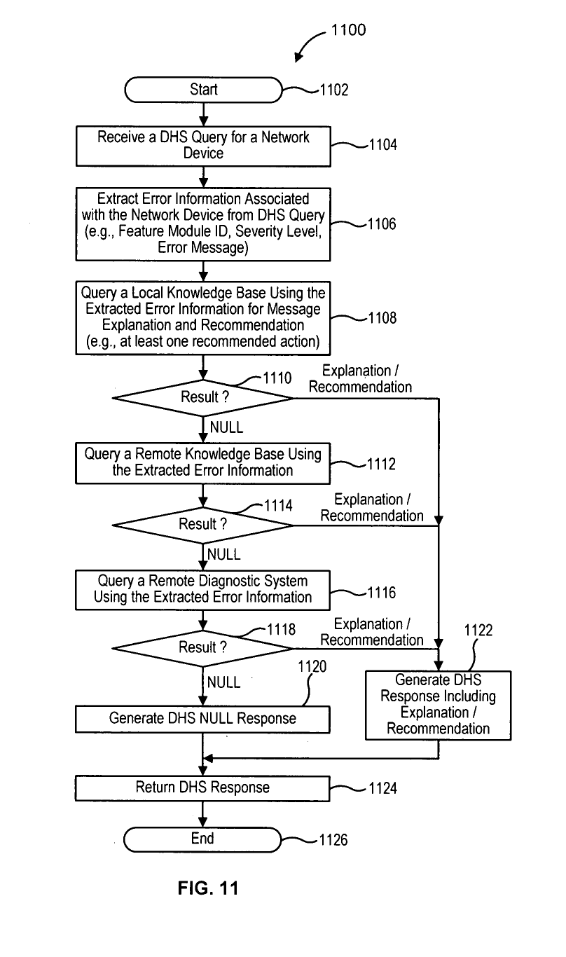

FIG. 11 is flowchart that illustrates an example method 1100 performed by the example DHS server 902 in accordance with FIGS. 9-10. The method 1100 begins at operation 1102. At operation 1104, the communication module 610 receives a DHS request 700 from DHS client 108, 302. At operation 1106, DHS request processing module 606 extracts error information 704-710 associated with the network device 106, 304, as identified by network device ID 702, from the DHS request 700. More specifically, error information may include feature module ID 704, severity level 706, error message 708 including one or more runtime parameters and any additional information 710. At operation 1108, the help retrieval module 1002 queries the local knowledge base (KB) 604 using the extracted error information and based at least in part on the one or more runtime parameters for amplification or explanation of error message and recommendation (e.g., at least one recommended action). If the help retrieval module 1002 determines that a result of the query at operation 1110 is NULL, the help retrieval module 1002 queries remote knowledge base 906 using extracted error information at operation 1112.

Further with reference to FIG. 11, if at operation 1114 the help retrieval module 1002 determines that the result of querying remote knowledge base 906 is NULL, the help retrieval module 1002 queries remote diagnostic system 908 using extracted error information and based at least in part on the one or more runtime parameters at operation 1116. If at operation 1118 the help retrieval module 1002 determines that the result of querying the remote diagnostic system 908 is NULL, the method 1100 continues at operation 1120 in which the DHS response processing module 608 generates a DHS NULL response at operation 1120 and the communication module 610 returns the DHS NULL response to the DHS client 108, 302 at operation 1124. Alternatively, if at any of the operations 1110, 1114 or 1118, the help retrieval module 1002 determines that the result of the query is not NULL (e.g., an explanation and recommendation retrieved), then the DHS response processing module 608 generates a DHS response at operation 1122 that includes the explanation and the recommendation (e.g., at least one recommended action) received from one of 604, 906, 908, and the communication module 610 returns the DHS response to the DHS client 108, 302 at operation 1124. The method 1100 ends at operation 1126.

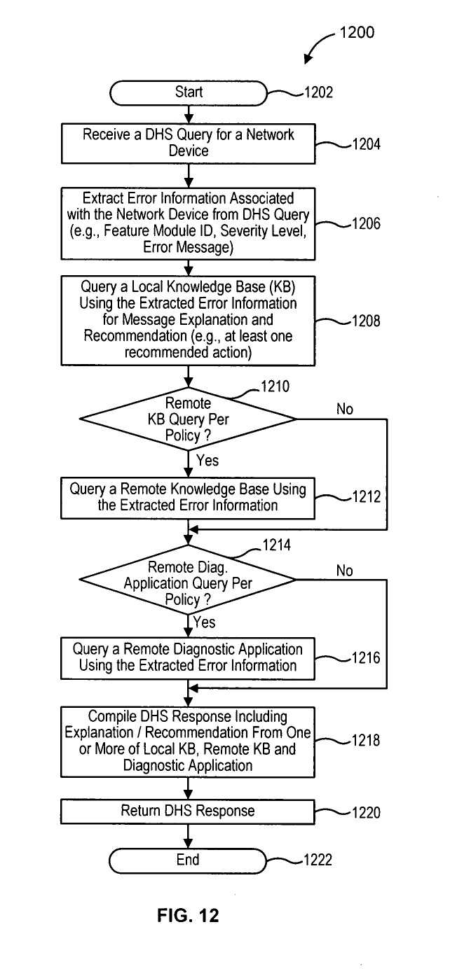

FIG. 12 is flowchart that illustrates another example method 1200 performed by the example DHS server 902 in accordance with FIGS. 9-10. The method 1200 begins at operation 1202. At operation 1204, the communication module 610 receives a DHS request 700 from DHS client 108, 302. At operation 1206, DHS request processing module 606 extracts error information 704-710 associated with the network device 106, 304, as identified by network device ID 702, from the DHS request 700. More specifically, error information may include feature module ID 704, severity level 706, error message 708 including one or more runtime parameters and any additional information 710. At operation 1208, the help retrieval module 1002 queries the local knowledge base (KB) 604 using the extracted error information and based at least in part on the one or more runtime parameters for amplification or explanation of error message and recommendation (e.g., at least one recommended action). Any returned explanation/recommendation from local knowledge base 604 may be buffered.

Further with reference to FIG. 12, at operation 1210 the help retrieval module 1002 determines based on query policy whether or not to query the remote knowledge base 906 using the extracted error information. If query policy indicates that the remote knowledge base 906 is to be queried, the help retrieval module 1002 queries the remote knowledge base 906 using extracted error information and based at least in part on the one or more runtime parameters at operation 1212. Any returned explanation/recommendation from remote knowledge base 906 may be buffered. Alternatively, if remote knowledge base 906 is not to be queried at operation 1210, the method 1200 continues at operation 1214, in which the help retrieval module 1002 determines based on query policy whether or not to query the remote diagnostic system 908 using the extracted error information. If query policy indicates that the remote diagnostic system 908 is to be queried, the help retrieval module 1002 queries the remote diagnostic system 908 using extracted error information and based at least in part on the one or more runtime parameters at operation 1216 and the method 1200 continues at operation 1218. Alternatively, if remote diagnostic system 908 is not to be queried at operation 1214, the method 1200 continues at operation 1218. At operation 1218, the response processing module 608 compiles a DHS response including explanation and recommended action (e.g., at least one recommended action), which may be buffered, from each of the local knowledge base 604, remote knowledge base 906 and remote diagnostic system 908. Thereafter, at operation 1220 the communication module 610 returns the DHS response to the DHS client 108, 302. The method 1200 ends at operation 1222.

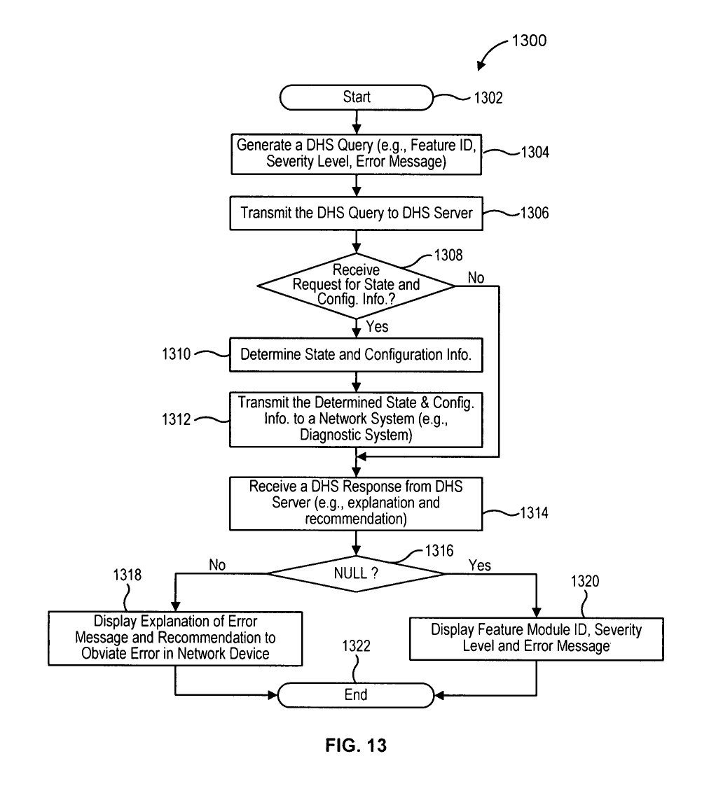

FIG. 13 is flowchart that illustrates an example method 1300 performed by the example network device 106 in accordance with FIGS. 1, 2 and 9. The method 1300 starts at operation 1302 at which point it is assumed that at least one feature module 202-206 has generated a system messages logged by the logger module 208. At operation 1304, in accordance with a manual user request or configuration, the DHS client module 108 generates a DHS query from a system message (e.g., including feature module ID, severity level and error message including one or more runtime parameters). At operation 1306, the communication module 218 transmits the generated DHS query to the DHS server 102, 902. At operation 1308, the communication module 218 determines whether a request for state and configuration information is received from a network system (e.g., diagnostic system 908 of FIG. 9). If so, at operation 1310 the state and configuration determination module 220 determines the state and configuration information of the network device 106. This may be accomplished by the state and configuration determination module 220 reading one or more log files (not shown), requesting information from one or more feature modules that may provide functionality for obtaining the desired state and configuration information, and the like. At operation 1312, the communication module 218 transmits the determined state and configuration information to the network system (e.g., diagnostic system 908). Thereafter, the method continues at operation 1314. However, if no request for state and configuration information is received at operation 1308, the method 1300 also continues at operation 1314. At operation 1314, the communication module 218 receives a DHS response from the DHS server 102. At operation 1316, DHS client module 108 determines whether the DHS response is NULL. If the DHS response is not NULL, at operation 1318 the DHS client 108 displays via display 216 at least one explanation of an error and associated recommendation (e.g., at least one recommended action) to obviate the error in the network device 106. More specifically, the DHS response may include explanation/recommendation from each of the local knowledge base 604, remote knowledge base 906 and remote diagnostic system 908. If at operation 1316 the DHS client module 108 determines that the DHS response is NULL, the DHS client module 108 displays via display 216 the feature module ID, severity level and error message from the original system message at operation 1320. The method 1300 ends at operation 1322.

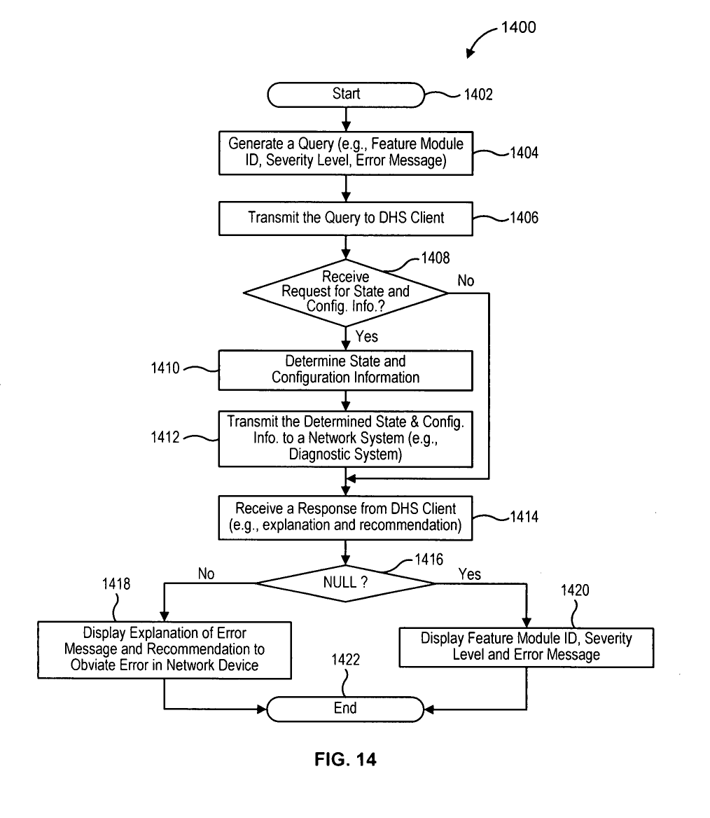

FIG. 14 is flowchart that illustrates an example method 1400 performed by the example network device 304 in accordance with FIGS. 3, 5 and 9. The method 1400 starts at operation 1402 at which point it is assumed that at least one feature module 202-206 has generated system messages logged by the logger module 208. At operation 1404, in accordance with a manual user request or configuration, the DHS client interface module 502 generates a query from a system message (e.g., including feature module ID, severity level and error message including one or more runtime parameters). At operation 1406, the communication module 218 transmits the generated query to the DHS client 302. At operation 1408, the communication module 218 determines whether a request for state and configuration information is received from a network system (e.g., diagnostic system 908 of FIG. 9). If so, at operation 1410 the state and configuration determination module 220 determines the state and configuration information of the network device 304. This may be accomplished by state and configuration determination module 220 reading one or more log files (not shown), requesting information from one or more feature modules that may provide functionality for obtaining the desired state and configuration information, and the like. At operation 1412, the communication module 218 transmits the determined state and configuration information to the network system (e.g., diagnostic system 908). Thereafter, the method continues at operation 1414. However, if no request for state and configuration information is received at operation 1408, the method 1400 also continues at operation 1414. At operation 1414, the communication module 218 receives a response from the DHS client 302. At operation 1416, DHS client interface module 502 determines whether the response is NULL. If the response is not NULL, at operation 1418 the DHS client interface module 502 displays via display 216 at least one explanation of an error and associated recommendation (e.g., at least one recommended action) to obviate the error in the network device 302. More specifically, the response may include explanation/recommendation from each of the local knowledge base 604, remote knowledge base 906 and remote diagnostic system 908. If at operation 1416 the DHS client interface module 502 determines that the response is NULL, the DHS client interface module 502 displays via display 216 the feature module ID, severity level and error message from the original system message at operation 1420. The method 1400 ends at operation 1422.

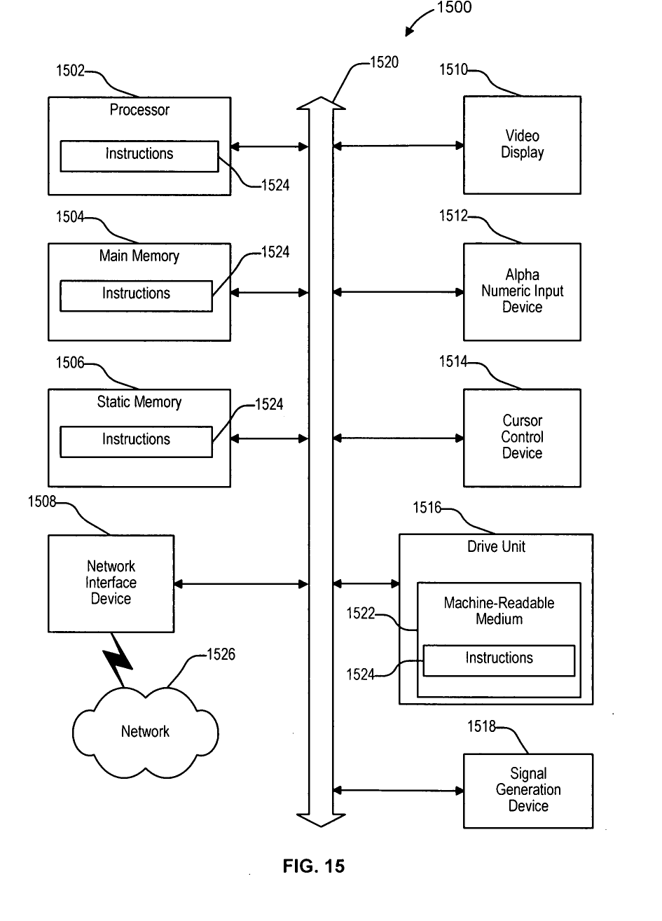

FIG. 15 is a diagrammatic representation of machine in an example form of a computer system within which a set of instructions, for causing the machine to perform any one or more of the methodologies discussed herein in FIGS. 1-14, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Further with reference to FIG. 15, the example computer system 1500 includes a processor 1502 (e.g., a central processing unit (CPU), a graphics processing unit (GPU) or both), a main memory 1504 and a static memory 1506, which communicate with each other via a bus 1520. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a user interface (UI) navigation device 1514 (e.g., a mouse), a disk drive unit 1516, a signal generation device 1518 (e.g., a speaker) and a network interface device 1508.

Still further with reference to FIG. 15, the disk drive unit 1516 includes a machine-readable medium 1522 on which is stored one or more sets of instructions and data structures (e.g., software 1524) embodying or utilized by any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media. The software 1524 may further be transmitted or received over a network 1526 via the network interface device 1508 utilizing any one of a number of well-known transfer protocols (e.g., HTTP).

Lastly with reference to FIG. 15, while the machine-readable medium 1522 is shown in the example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of an example embodiment, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may be implemented as hardware circuitry, optical components, single or multi-processor circuits, memory circuits, software program modules and objects, firmware, and combinations thereof, as appropriate for particular implementations of various embodiments.

Thus, an example system, method and logic to provide additional information and recommended action relating to error information reported by a feature module of a network device have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

What is claimed is:

1. A method comprising:
generating a request that includes error information reported by a feature module of a network device, the error information including one or more runtime parameters associated with the network device;
transmitting the generated request; and
receiving a response to the request, the response including additional information and at least one recommended action relating to the error information, the additional information and the at least one recommended action being based at least in part on the one or more runtime parameters.

2. The method of claim 1, further comprising displaying the additional information and the at least one recommended action to a user.

3. The method of claim 1, wherein transmitting the request comprises transmitting the request to a help server, the error information included in the request comprising an identification of the feature module, an error message reported by the feature module, and a severity level of the error message reported by the feature module.

4. The method of claim 3, further comprising querying by the help server at least one data source to determine one or more of the additional information and the at least one recommended action.

5. The method of claim 3, further comprising querying by the help server a diagnostic module to determine one or more of the additional information and the at least one recommended action.

6. The method of claim 5, further comprising the retrieving by the diagnostic module a state and context of the network device in order to determine one or more of the additional information and the at least one recommended action.

7. The method of claim 1, wherein transmitting the request comprises:
transmitting the request from the network device to a help client;
generating a help query based on the request; and
transmitting the generated help query from the help client to a help server.

8. The method of claim 7, wherein receiving the response comprises:
receiving help data at the help client from the help server;
generating a response to the request based on the help data; and
transmitting the generated response to the network device.

9. A system comprising:
a help module to:
generate a request that includes error information reported by a feature module of a network device, the error information including one or more runtime parameters associated with the network device, and
receive a response to the request, the response including additional information and at least one recommended action relating to the error information, the additional information and the at least one recommended action being based at least in part on the one or more runtime parameters; and
a communication module to transmit the generated request and to receive the response to the request.

10. The system of claim 9, further comprising a console module to display to a user on a display device the additional information and the at least one recommended action.

11. The system of claim 9, wherein the communication module transmits the request to a help server, the error information included in the request comprising an identification of the feature module, an error message reported by the feature module, and a severity level of the error reported by the feature module.

12. The system of claim 11, wherein the help server comprises a help retrieval module to query at least one data source to determine one or more of the additional information and the at least one recommended action.

13. The system of claim 12, wherein the help server further comprises a diagnostic retrieval module to query a diagnostic module to determine one or more of the additional information and the at least one recommended action.

14. The system of claim 13, wherein the diagnostic module includes a state and context retrieval module to retrieve the state and context information of the network device in order to determine one or more of the additional information and the at least one recommended action.

15. The system of claim 11, further comprising a help client comprising:
a request handler module to receive the request and generate a help request based on the received request;
a help request dispatch module to receive the request from the help module, to forward the request to the request handler module, to receive the generated help request from the request handler module and to transmit the received help request; and
a communication module to receive the help request from the help request dispatch module and to transmit the received help request to the help server.

16. The system of claim 15, the help client further comprising:
a response renderer module to receive a help response to the help request and to generate a response based on the help response;
a help response receiver module to receive the help response from the help server, to forward the help response to the response renderer module, to receive the generated response from the response renderer module, and to forward the generated response; and
the communication module further to receive the generated response and to transmit the generated response to the network device.

17. The system of claim 9, wherein the network device is one selected from the group consisting of: a gateway; a router; a switch; a bridge; a hub; a repeater; a host device; and a terminal device.

18. A logic encoded in one or more tangible media for execution and when executed operable to:
generate a request that includes error information reported by a feature module of a network device, the error information including one or more runtime parameters associated with the network device;
transmit the generated request; and
receive a response to the request, the response including additional information and at least one recommended action relating to the error information, the additional information and the at least one recommended action being based at least in part on the one or more runtime parameters.

19. A system comprising:
a means for generating a request that includes error information reported by a feature module of a network device, the error information including one or more runtime parameters associated with the network device;
a means for transmitting the generated request; and
a means for receiving a response to the request, the response including additional information and at least one recommended action relating to the error information, the additional information and the at least one recommended action being based at least in part on the one or more runtime parameters.

20. A network device comprising:
a feature module to report error information including one or more runtime parameters associated with a network device;
a help module to generate a request including the error information reported by the feature module, and to receive a response to the request, the response including additional information and at least one recommended action relating to the error information, the additional information and the at least one recommended action being based at least in part on the one or more runtime parameters; and
a communication module to transmit the generated request and to receive the response to the request.

21. The network device of claim 20, further comprising a console module to display to a user on a display device the additional information and the at least one recommended action.

22. The network device of claim 20, wherein the communication module transmits the request to a help server and receives the response from the help server.

23. The network device of claim 20, wherein the communication module transmits the request to a help client and receives the response from the help client.

24. The network device of claim 20, wherein the network device is one selected from the group consisting of: a gateway; a router; a switch; a bridge; a hub; a repeater; a host device; and terminal device.
